(19) United States
(12) Patent Application Publication
(10) Pub. No.: US 2005/0140785 A1
(43) Pub. Date: Jun. 30, 2005

(54) 360 degree video camera system

(76) Inventor: Joseph J. Mazzilli, Bellmore, NY (US)

Correspondence Address: Law Office of Richard B. Klar, 28 East Old Country Road, Hicksville, NY, 11801, US

(21) Appl. No.: 11/064,613

(22) Filed: Feb. 24, 2005

Related U.S. Application Data
(63) Continuation-in-part of application No. 10/005,380, filed on Dec. 3, 2001, now abandoned.
Application No. 10/005,380 is a continuation-in-part of application No. 09/494,060, filed on Jan. 28, 2000, now Pat. No. 6,333,759.
(60) Provisional application No. 60/124,624, filed on Mar. 16, 1999.

(51) Int. Cl. H04N 7/18

(52) U.S. Cl. 348/148; 348/143

(57) ABSTRACT

The present invention relates to a video camera system which has a 360° range for digital video recording inside and outside of an automotive vehicle.

### RELATED APPLICATION

The present application is a continuation in part application of U.S. patent application Ser. No. 10/005,380 filed on Dec. 3, 2001 which in turn is a continuation in part application of U.S. patent application Ser. No. 09/494,060 filed on Jan. 28, 2000 which has issued as U.S. Pat. No. 6,333,759 and which in turn is a continuation in part of Provisional U.S. patent application Ser. No. 60/124,624 filed on Mar. 16, 1999 and for which priority is claimed under 35 USC 120.

### BACKGROUND OF THE INVENTION

1. Field of the Invention

The present invention relates to a video or digital camera system in an automobile, truck, train, back of van, in an office or residential room such as the living room or bedroom of a house or an apartment. In particular the present invention relates to a video camera which has a 360° range for video or digital recording around the environment in which the invention is located thereby providing documentation for police officers or vehicle owners as well as security in the transportation areas, home and office areas to protect against terrorism as well as theft.

2. The Prior Art

The use of videotaping systems for an automobile is known. U.S. Pat. No. 4,789,904 relates to a vehicle mounted surveillance system. The system has a camera and a control head inside a police vehicle and a video recorder in a bullet proof, fire proof vault of the vehicle.

The system is used as a surveillance system to videotape located in the trunk of a vehicle.

It would be preferred to have a system with a 360° range for video taping a 360° area simultaneously thus videotaping both inside and outside of the vehicle. It would be preferable to be able to retract the camera when not in use.

### SUMMARY OF THE INVENTION

It is a principal object of the present invention to provide a video or digital camera system for documentary videotaping in a 360° range around the camera's location.

It is another object to provide a 360° range camera to be located on a windshield of a vehicle such as a truck.

It is a further object to VCR (video-cassette recorder) for ready image.

It is another object to provide a commercial VCR system which operates off the automotive vehicle's battery.

It is still another object to locate the multiplexer and VCR either inside a glove compartment or a trunk of the automotive vehicle.

It is a further object to provide a video camera system which provides a 360 degree simultaneous video taping documentation for police officers to serve as evidence for appropriate situations when vehicles and/or individuals are within range of the police officer's vehicle.

It is still another object to provide a video camera system which provides a 360 degree simultaneous video taping documentation for vehicle owners to serve as evidence of vehicle theft or police abuse that occur within range of the owner's vehicle.

It is yet another object to provide a video camera system which provides a 360 degree simultaneous video taping documentation for vehicle owners to serve as documentation of accidents and injuries and for related insurance purposes therefor that occur within range of the owner's vehicle.

It is still another object to provide a video camera system for transportation vehicles including cars, trucks, train cars, boats, planes which provides a 360 degree simultaneous video taping documentation for transportation vehicle owners and security and law enforcement against terrorist activities and to serve as evidence of the same as well as against vehicle theft or police abuse that occur within range of the owner's vehicle with documentary evidence of the same.

Other objects will become readily apparent from the foregoing description and accompanying drawings in which:

### BRIEF DESCRIPTION OF THE DRAWINGS

FIG. 1 is a top view of the present invention;

FIG. 2 is a view of the monitor along line 2 of FIG. 1;

FIG. 3 is a partial sectional view along lines 3-3 of FIG. 1;

FIG. 4 is a partial sectional view of line 4-4 of FIG. 3; and

FIG. 5 is an alternative embodiment of the invention in which the camera has a circularly-shaped housing; and

FIG. 6 is another alternative embodiment of the present invention in which the camera has a cube-shaped housing;

FIG. 7 is another alternative embodiment of the present invention in which each of four cameras can be built into the mirror or mirror housing of the rear view mirror on different sides of the mirror so as to provide a three hundred and sixty degree view around the rear view mirror; and

FIG. 8 is a front view of the embodiment of FIG. 7 in which a camera (camera 1 is built into the front surface of the rear view mirror and two other cameras (cameras 3 and 4 are built into opposite side surfaces of the rear view mirror;

FIG. 9 is a side view of the embodiment of FIG. 7 showing camera 4 built into the side surface of the rear view mirror; and

FIG. 10 is a rear view of the embodiment of FIG. 7 showing a camera (camera 2) built into the rear surface of the rear view mirror;

FIGS. 11A and 11B illustrate the invention mounted onto the windshield of a truck;

FIG. 12 illustrates the invention located on the ceiling in the inside of the back of a van; and

FIG. 13 illustrates the invention located on the ceiling of an office.

### DETAILED DESCRIPTION OF THE PREFERRED EMBODIMENTS

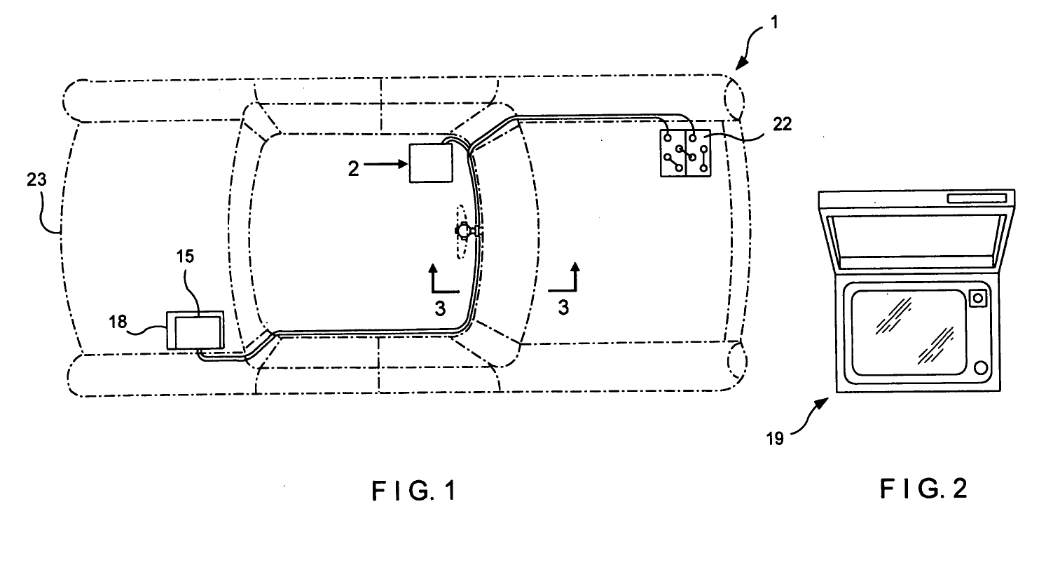

Referring to the drawings, FIG. 1 shows a top view of the invention, a 360 degree video camera system inside of an automotive vehicle 1. The 360 degree camera system includes a camera housing 5, a multiplexer unit 15 and a video cassette recorder (VCR) 18 and optionally a monitor 19, as shown in FIGS. 1 and 2.

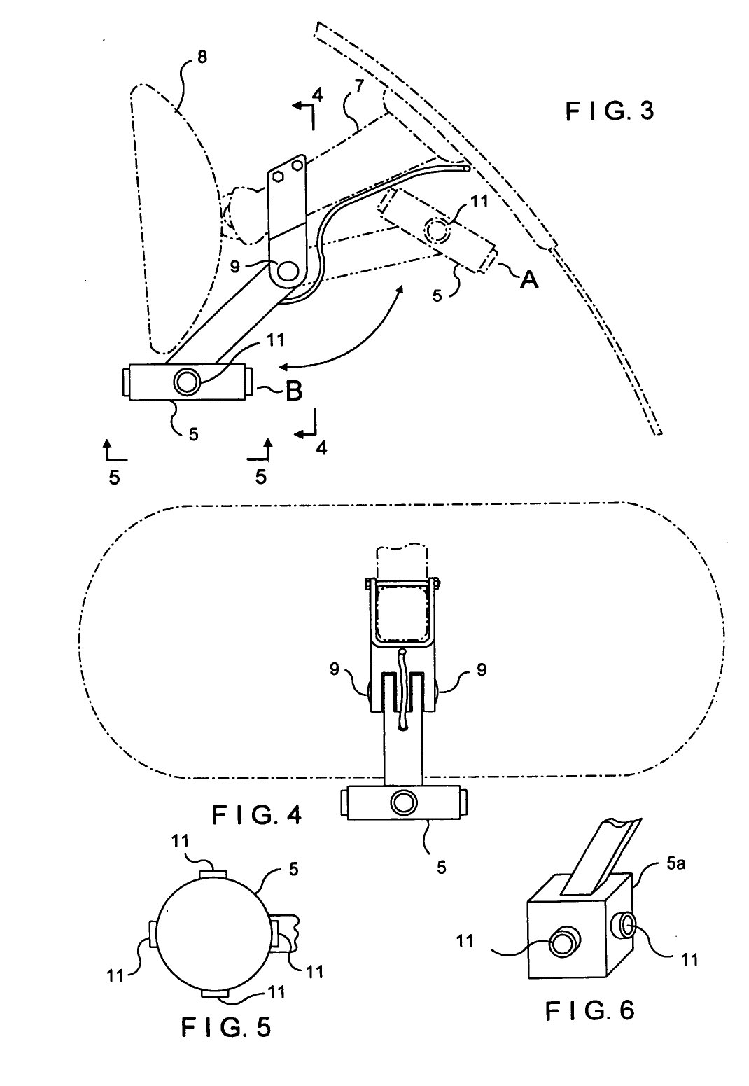

The camera housing 5, as shown in FIG. 3, can be mounted on the supporting mount 7 of the rear view mirror 8 of the automotive vehicle 1. As shown in FIG. 3, the camera housing 5 can be moved so that it can be retracted and placed behind the rear view mirror 8 in position A when not in use or extended below the rear view mirror 8 in position B when in use. A hinge mechanism 9 can articulately move the camera on its mount from position A to position B and vice verse. Alternatively other mechanical arrangements might be employed such as having the camera mount designed as a telescopic rod for extending and retracting the camera behind or below the rear view mirror respectively.

The camera housing 5 is preferably formed to accommodate a 4 Board CCD or a PC51 Series CMOS inline Microvideo Camera sold by Super Circuits, Inc., Leander, Tex., which is mounted on a 1 inch to 2 inch mount giving it a 360 degree view inside and outside the vehicle. These miniature video cameras can be black and white or color cameras. It is understood, however, that any other miniature camera system can be used and the invention is not limited to these specific examples.

There is a swivel unit for the camera housing 5 which attaches to the rear view mirror.

The system includes preferably a 5 inch or 6 inch LCD video monitor for viewing the camera recorded images (FIG. 2). The monitor can be color or black and white and can flip up or down.

Wires run from the camera housing to the multiplexer which records with time and date, either in color or black and white, all four miniature video cameras at the same time. Then the wires run into a VCR which along with the miniature video cameras and multiplexer operate off the vehicle's battery 22, preferably by a wire harness (not shown) to which the wires for the miniature cameras, the multiplexer 15 and the VCR 18 run and from which the wire harness connects to the vehicle's battery 22.

Preferably, the camera housing 5 can be configured into any geometric shape and is not limited to the shapes described herein. FIGS. 3-5 shows the camera housing as a ring shaped or circular housing with lenses on each side. Preferably four miniature video cameras are provided on each side of the housing spaced 90 degrees apart but the number of cameras 11 can vary if desired. The miniature video cameras 11 provide the camera housing 5 with a 360 degree range for video recording everything around the camera housing 5, namely the interior of the automotive vehicle and the exterior of the automotive vehicle by recording through the windshield, side and rear windows of the automotive vehicle 1. The camera housing 5 and cameras 11 can run off the automotive vehicle's battery as shown in FIG. 1.

The system includes a multiplexer 15 and a VCR 18. The multiplexer 15 permits all the recorded view from each camera 11 of the camera housing 5 to be placed together to provide a 360 degree picture. Thus in a four-camera arrangement, the multiplexer 15 provides for the four cameras' images to be placed side by side by side by side for display as recorded in the VCR 18 and displayed in the monitor 19. The VCR 18 records these images. One suitable multiplexer 15 for the present invention is Model No. DPX4 for color video taping and Model No. MX4M for black and white video taping available from Advanced Technology Video Inc. of Redmond, Wash. Of course the present invention is not limited to any one particular multiplexer model.

The multiplexer 15 and the VCR 18 are placed together and preferably stacked one on top of the other either in the trunk 22 of the automotive vehicle as shown in FIG. 1 or in the glove compartment of the automotive vehicle (not shown).

The wiring between the camera housing 5, the multiplexer 15 and VCR 18 and optionally the monitor 19 can be placed behind the panels of the sidewalls, roof and dashboard of the vehicle as shown in FIG. 1 to keep the installation of the present invention less intrusive and the wiring concealed for aesthetic appearances. The monitor 19, VCR 18 and the multiplexer 15 can also run off the automotive vehicle's battery 22. Thus, preferably, all four video cameras 11, the multiplexer 15 and the VCR 19 have wires running to a wire harness which is connected to the vehicle's battery 22. Alternatively any other power supply can be provided such as batteries for the camera, multiplexer and VCR.

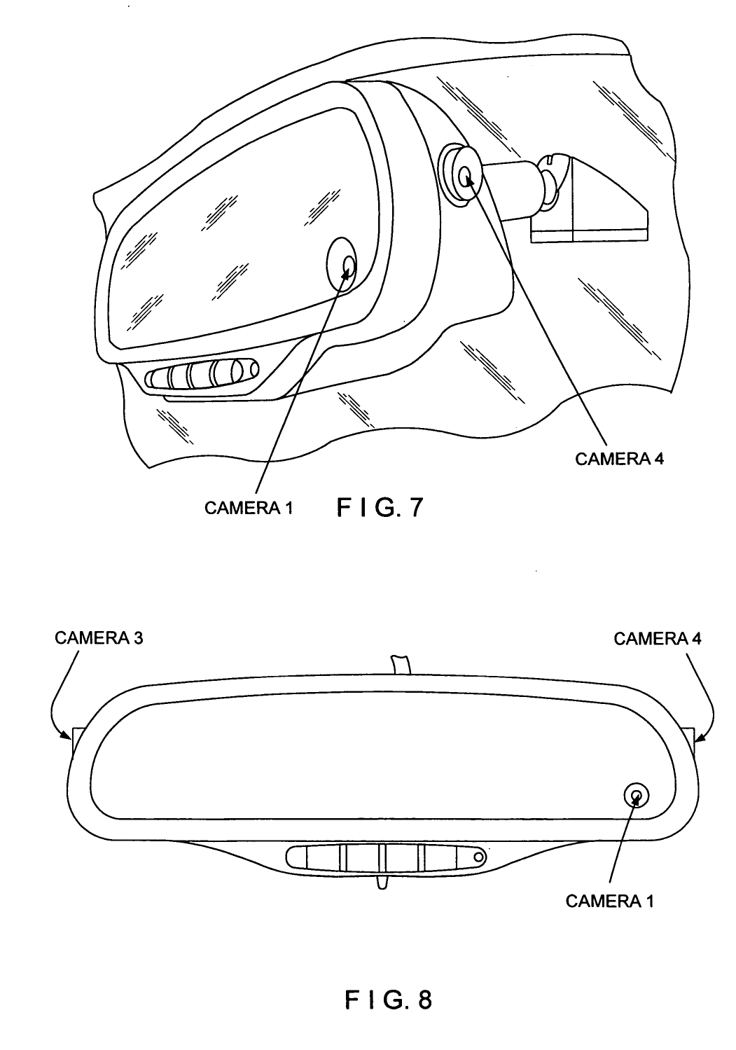

Alternatively, the camera housing 5 can be part of the housing of the rear view mirror. In other words, the camera housing can be incorporated or built into the housing of the rear view mirror (See the embodiment described below with reference to FIGS. 7-10).

In another embodiment (not shown), the miniature video camera can be a miniature digital camera and instead of a multiplexer unit and a VCR, the miniature digital camera would be wired into digital recording system. The digital recording system would be located in either the glove compartment or the trunk in place of the multiplexer unit and the VCR and similarly the miniature digital camera would be located as described for the location of the camera and camera housing 5 herein. Examples of digital video cameras that can be used in the present invention include but are not limited to JVC DVM 90 and Sony DCRPC 9. Examples of digital video cameras that can be used include but are not limited to Sony GVD 300, Sony GVD 600 and Mobil view II Digital Recorder.

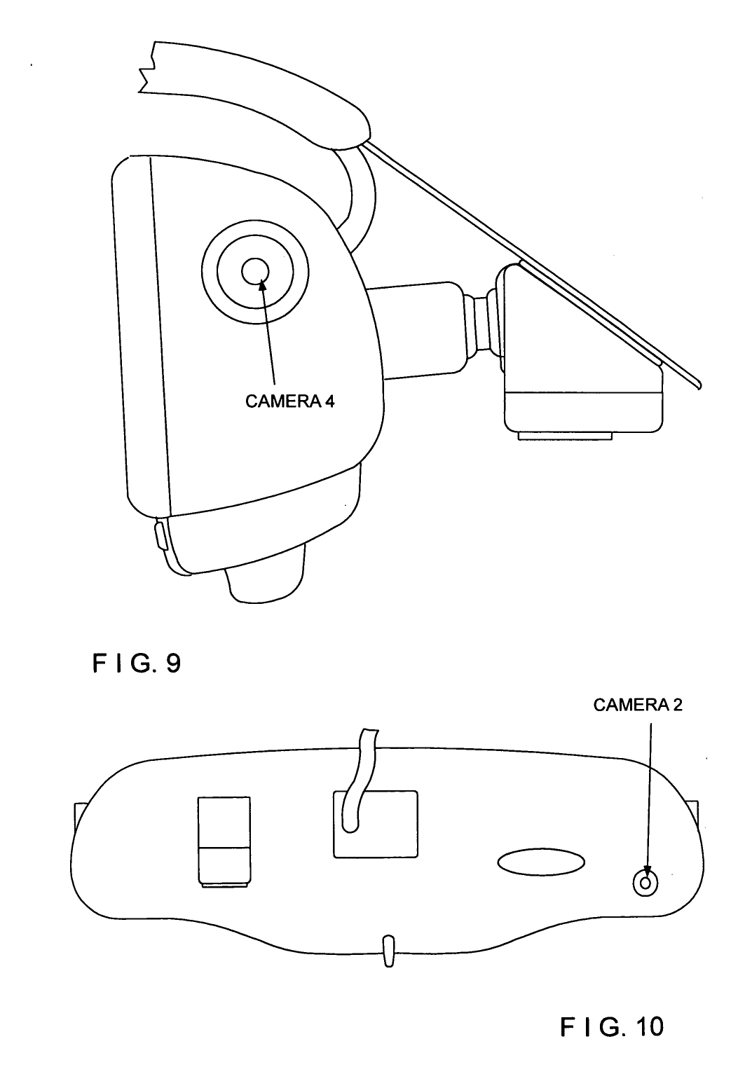

In still another embodiment of the present invention a miniature 4 camera system can be built into the rear view mirror or its housing. As shown in FIGS. 7-10 four cameras (cameras 1, 2,3 and 4) are built into the rear view mirror. As seen in FIG. 7 Camera 1 is built into the front surface of the rearview mirror and cameras 3 and 4 are built into the opposite side surfaces of the rear view mirror (see FIGS. 8 and 9). FIG. 10 illustrates that another camera, camera 2 is built into the rear side of the rear view mirror. Thus the four cameras built into the rear view mirror provide for a three hundred and sixty degree viewing around the rear view mirror. Further a monitor can be installed and attached to the rear view mirror which can flip down from the mirror for viewing. It is understood that the present invention is not limited to the number of cameras shown or the specific locations illustrated in the drawings. Alternately, the monitor can be located elsewhere in the automotive vehicle (not shown). One or more of these miniature camera system are custom designed by SVS (Subsea Video Systems, Inc.) Having an address in Elizabeth City, N.C. These miniature camera system has the following specifications:

Miniature 4 day/night cameras, rear view mirror, in car video system externally mounted-clip-on version with a 480 lines of high resolution, flip down color LCD view screen (the flip down monitor) with camera switcher (1-5 cameras): Pickup element: ⅓″ CCD, Snc: Internal; AGC: Automatic; Video Output: Composite (1vp-p); white balance: automatic; minimum illumination: 0.3 lux., 0.0 lux; voltage: 10-16 V DC, 150 mA; Dimensions: 1.75 Dia.×2.5 inches Lg.; Weight: 154 grams; shock: Above 1000 g; Temperature: −40 degrees C. to +50 degrees C.; Lens face: Pyrex tempered.

A high resolution 16× color zoom camera is also being custom built by SVS for the present invention with the following specifications:

This high resolution color day/night camera offers a remote controlled motorized or manual zoom lens with a 16× zoom o 3.9 to 54.6 mm. The lens also incorporates an auto focus feature thereby minimizing control functions. The remote zoom control unit is also included with the camera. As with all our cameras the AV-Z is waterproof and rated to our minimum specification of 300 foot water depth. The micro lens motors do not allow for 1000 g shock levels but with our specialized camera hardening techniques it can still achieve an impressive 150 g continuous shock at 0.5 millisecond, still exceeding any other standard video camera specifications. An optional RS-232 serial data port is available for full computer control with over 10 controllable functions. This system provides for a true harsh environmental video camera.

The specifications for this camera system include:

Pickup element: ¼ CCD, Snc: Internal; AGC: Automatic; Video Output: Composite (1vp-p); white balance: automatic; minimum illumination: 0.01 lux.; voltage: 10-16 V DC, shock: 150 g; Temperature: −40 degrees C. to +50 degrees C.; Lens face: Pyrex tempered.

A further embodiment which may utilize the camera systems such as those which are being custom built by SVS manufactured utilizes a DVR or digital video recorder as the digital recording system and does not require a multiplexer in the present invention. The camera system can either be wired for transmission to the DVR or can communicate with the DVR by wireless transmission. The DVR can be located in the automotive vehicle or at a remote location from the automotive vehicle so that the camera system can communicate with the DVR by wireless transmission. Again one version of this DVR is being custom built by SVS as a portable/mobile video recorder having the following features;

broadcast quality MPEG 1 and 2 recording, 1-5 cameras, 30FPS; Programable

e video compression for, optimum recording; 1 channel audio recording with wearable, wireless microphone (600′ transmission from car); instant replay of 1-5 cameras while still recording; compatible with NTSC or PAL; simple VCR like wearable wireless remote operation; computer/Internet accessible with secure password protection and up to 30 days recording with the aforementioned camera systems being custom built by SVS.

The specifications include:

ISO/IEX 13188-3,2 (MPEG-2); Stream Types: Elementary, Program and Transport., Half PEL accuracy; Video Encoder: Horizontal Resolution—720,640,480,320,160; Vertical Resolution—480,240,112(NTSC), 576,288, 144 (PAL); Preprocessor: programmable 2D (7×6) filter spatial noise reduction; Motion Estimation: Pand B-pictures +/−100 (H) X+/−34 (V); Inputs: (a) Composite Video: 1x, Input Impedance: 75 Ohm, 1.0Vp-p Standards 525/60 (NTSC), 625/50 (PAL); Audio: 1x; Balanced Level—Up to 3V p-p.

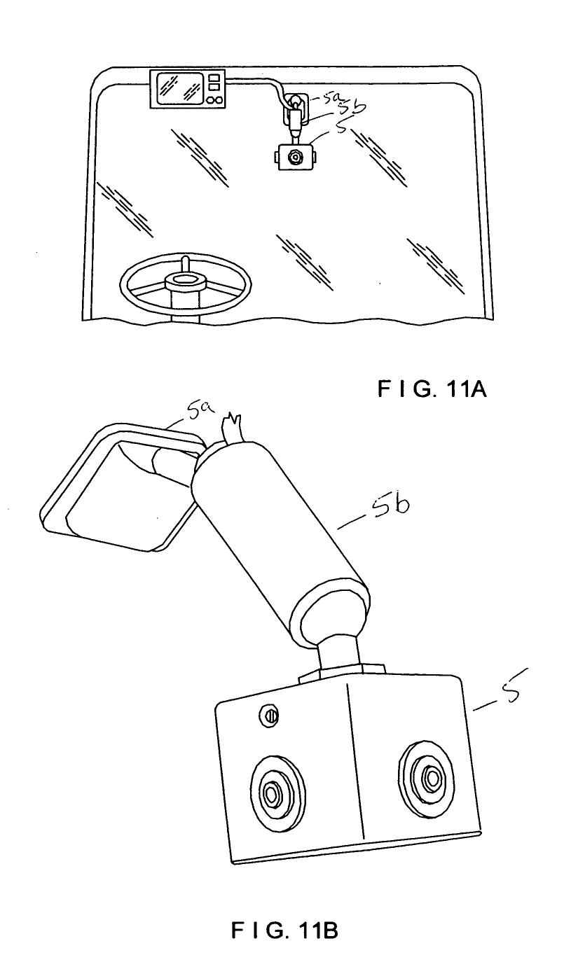

FIGS. 11A and 11 B illustrate how the camera housing 5 can mounted onto the windshield of a truck in the same manner known for mounting a rearview mirror onto the windshield of car. The camera housing 5 can be mounted onto the windshield by means of a bracket 5a and a stem 5b as shown in FIGS. 11A and 11B.

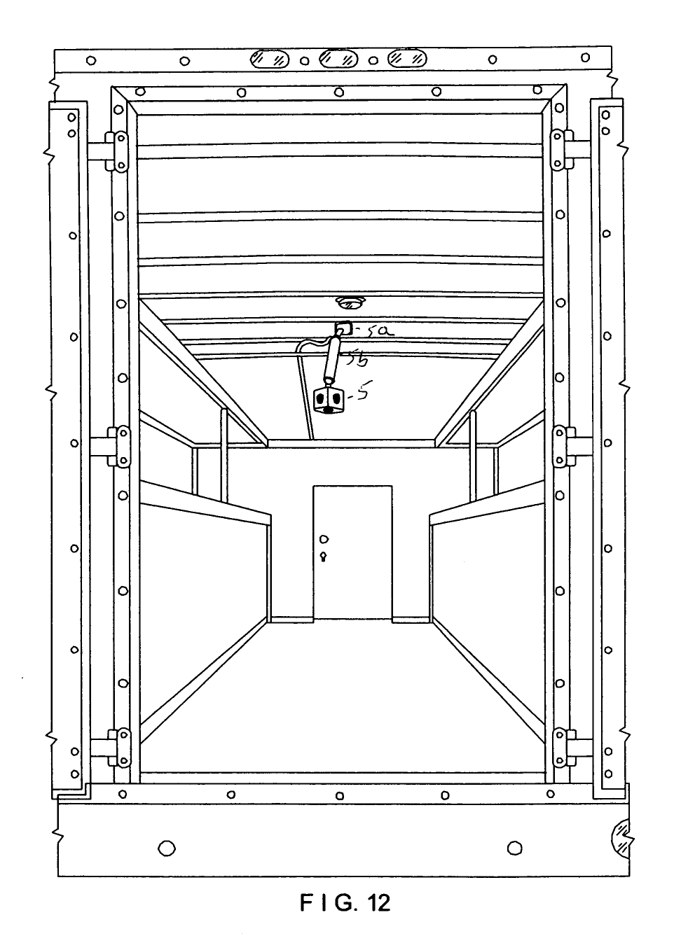

Although the invention is described in particular for use in automotive vehicles, it can also be utilized in other vehicles involving but not limited to aircrafts, boats, trains, etc. IN FIG. 12 a camera housing 5 can be located on the ceiling in the back of a van and can be mounted by means of a bracket 5a and a stem 5b. This way the present invention provides a 360 degree view of the inside of the back of the van and helps to provide security surveillance for valuables transported in the back of the van.

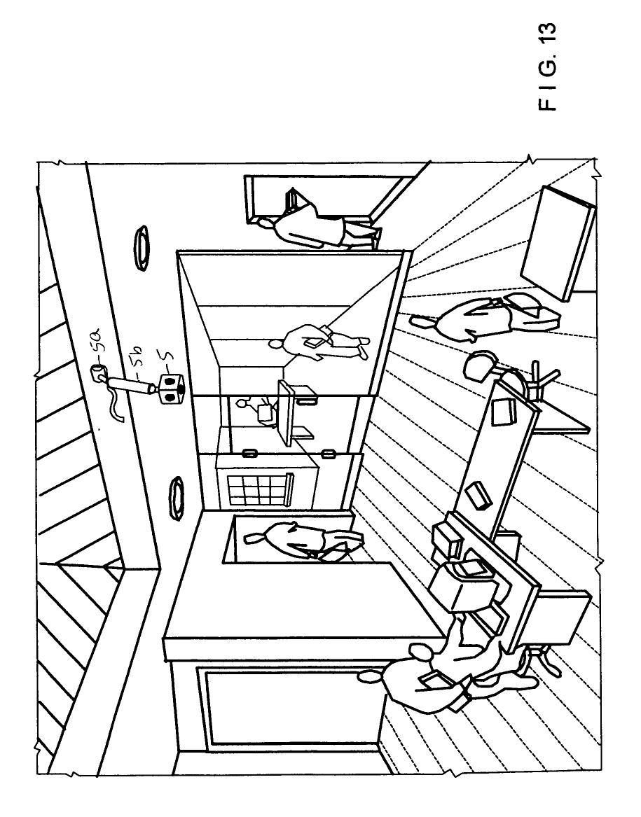

FIG. 13 illustrates how the present invention can be used in locations other than vehicles. In FIG. 13 the camera housing 5 is located in an office room suspended from a ceiling by means of a bracket 5a and a stem 5b. This provides for a 360 degree viewing of the office environment for security purposes. The present invention can also be placed on a table top or a desk top for a 360 degree viewing from that location in an office environment or in a residential dwelling such as a house or an apartment. The present invention can be placed to be suspended from a ceiling in a residential dwelling as well.

While presently preferred embodiments have been described for purposes of the disclosure, numerous changes in the arrangement of method steps and apparatus parts can be made by those skilled in the art. Such changes are encompassed within the spirit of the invention as defined by the appended claims.

1. An image recording system, comprising:
a camera housing including a plurality of cameras, located on each side of said housing to provide a 360° range for video recording images received by said lenses;
a recorder for multiplying and recording all recorded images received from said cameras thereby providing a recording of a 360° environment surrounding said camera housing.

2. The system according to claim 1 wherein said camera housing is mounted on a windshield of a vehicle.

3. The system according to claim 2 wherein said vehicle is a truck and said camera housing is mounted onto the windshield of said truck by means of a bracket and a stem.

4. The system according to claim 1 wherein said camera housing is located in a vehicle.

5. The system according to claim 4 wherein said camera housing is suspended from a ceiling inside said vehicle.

6. The system according to claim 4 wherein said vehicle is a train car.

7. The system according to claim 4 wherein said vehicle is a plane

8. The system according to claim 4 wherein said vehicle is a truck.

9. The system according to claim 4 wherein said vehicle is a ship.

10. The system according to claim 1 wherein said camera housing is located inside an office room.

11. The system according to claim 10 wherein said camera housing is suspended from a ceiling of said office room.

12. The system according to claim 10 wherein said camera housing is placed on a desk or a table inside said office room.

13. The system according to claim 1 wherein said camera housing is located inside a room of a residence.

14. The camera system according to claim 13 wherein said camera housing is suspended from a ceiling of said room of said residence.

15. The system according to claim 13 wherein said camera housing is placed on a desk or a table inside said office room

16. The system according to claim 1 wherein said cameras transmit said recorded images to a digital video recorder by wireless transmission.

17. The system according to claim 1 wherein said cameras transmit said recorded images to said digital video recorder by wired transmission.

18. The system according to claim 1 wherein said camera housing is shaped circularly and each of said cameras is located 90 degrees apart from each other.

19. The system according to claim 1 wherein said camera housing is cube shaped and each side surface of said cube shaped camera housing has a lens therein.
